(19) United States
(12) Patent Application Publication
(10) Pub. No.: US 2014/0149845 A1
(43) Pub. Date: May 29, 2014

(54) METHOD FOR GENERATING WEBSITES

(71) Applicants: Locu, Inc., San Francisco, CA (US); Go Daddy Operating Company, LLC, Scottsdale, AZ (US)

(72) Inventors: Jason Ansel, Cambridge, MA (US); Sandeep Grover, Sunnyvale, CA (US); Adam Marcus, Cambridge, MA (US); Keir Mierle, San Francisco, CA (US); Rajatish Mukherjee, Sunnyvale, CA (US); Rajinder Nijjer, Phoenix, AZ (US); Marek Olszewski, San Francisco, CA (US); Marc Piette, San Francsico, CA (US); Rene Reinsberg, San Francsico, CA (US)

(21) Appl. No.: 14/081,954

(22) Filed: Nov. 15, 2013

Related U.S. Application Data
(63) Continuation-in-part of application No. 13/605,051, filed on Sep. 6, 2012.
(60) Provisional application No. 61/818,713, filed on May 2, 2013.
(60) Provisional application No. 61/818,736, filed on May 2, 2013.

(51) Int. Cl. G06F 17/22

(52) U.S. Cl. CPC G06F 17/2247
USPC 715/234

(57) ABSTRACT

A method for generating a website includes obtaining a seed input associated with an entity. The seed input may include one or more keywords, such as a business name. Obtaining the seed input may include receiving the seed input from the user, or the seed input may be obtained without input from the user. The seed input is used to identify the entity. The method further includes retrieving, using at least one of the seed input and the identification of the entity, content relevant to the entity from one or more data stores. Retrieving the content may include using one or more categories relevant to the entity to identify the content. The website is generated without an input from the entity, and includes at least a portion of the content. Generating the website may include identifying a template having a plurality of content regions for containing the content.

### CROSS-REFERENCE TO RELATED APPLICATIONS

This patent application is a non-provisional and claims the benefit of U.S. Provisional Pat. App. Ser. Nos. 61/818,713 and 61/818,736, both filed May 2, 2013, and this patent application is a continuation-in-part and claims the benefit of U.S. patent application Ser. No. 13/605,051, filed Sep. 6, 2012, all of which applications are incorporated herein by reference.

### FIELD OF THE INVENTION

The present invention generally relates to website design and communication, and, more specifically, to systems and methods for efficiently and effectively generating a website that conveys desired information to various requesters.

### BACKGROUND OF THE INVENTION

The Internet comprises a vast number of computers and computer networks that are interconnected through communication links. The interconnected computers exchange information using various services. In particular, a server computer system, referred to herein as a web server, may connect through the Internet to a remote client computer system and may send, to the remote client computer system upon request, one or more websites containing one or more graphical and textual web pages of information. A request is made to the web server by visiting the website's address, known as a Uniform Resource Locator (“URL”). Upon receipt, the requesting device can display the web pages. The request and display of the websites are typically conducted using a browser. A browser is a special-purpose application program that effects the requesting of web pages and the displaying of web pages.

Browsers are able to locate specific websites because each website, resource, and computer on the Internet has a unique Internet Protocol (IP) address. Presently, there are two standards for IP addresses. The older IP address standard, often called IP Version 4 (IPv4), is a 32-bit binary number, which is typically shown in dotted decimal notation, where four 8-bit bytes are separated by a dot from each other (e.g., 64.202.167.32). The notation is used to improve human readability. The newer IP address standard, often called IP Version 6 (IPv6) or Next Generation Internet Protocol (IPng), is a 128-bit binary number. The standard human readable notation for IPv6 addresses presents the address as eight 16-bit hexadecimal words, each separated by a colon (e.g., 2EDC:BA98:0332:0000:CF8A:000C:2154:7313).

IP addresses, however, even in human readable notation, are difficult for people to remember and use. A URL is much easier to remember and may be used to point to any computer, directory, or file on the Internet. A browser is able to access a website on the Internet through the use of a URL. The URL may include a Hypertext Transfer Protocol (HTTP) request combined with the website's Internet address, also known as the website's domain name. An example of a URL with a HTTP request and domain name is: http://www.companyname.com. In this example, the “http” identifies the URL as a HTTP request and the “companyname.com” is the domain name. A domain can further host multiple websites that can be accessed by appending character strings that constitute the full path to the website's files. For example, the domain for FACEBOOK includes one or more websites, as the term is used herein, for each of its users. A user-specific website is requested by appending a directory to the FACEBOOK main URL, e.g.: http://www.facebook.com/username.

Domain names are much easier to remember and use than their corresponding IP addresses. The Internet Corporation for Assigned Names and Numbers (ICANN) approves some Generic Top-Level Domains (gTLD) and delegates the responsibility to a particular organization (a “registry”) for maintaining an authoritative source for the registered domain names within a TLD and their corresponding IP addresses. For certain TLDs (e.g., .biz, info, .name, and .org) the registry is also the authoritative source for contact information related to the domain name and is referred to as a “thick” registry. For other TLDs (e.g., .com and .net) only the domain name, registrar identification, and name server information is stored within the registry, and a registrar is the authoritative source for the contact information related to the domain name. Such registries are referred to as “thin” registries. Most gTLDs are organized through a central domain name Shared Registration System (SRS) based on their TLD.

The process for registering a domain name with .com, .net, .org, and some other TLDs allows an Internet user to use an ICANN-accredited registrar to register their domain name. For example, if an Internet user, John Doe, wishes to register the domain name “mycompany.com,” John Doe may initially determine whether the desired domain name is available by contacting a domain name registrar. The Internet user may make this contact using the registrar's webpage and typing the desired domain name into a field on the registrar's webpage created for this purpose. Upon receiving the request from the Internet user, the registrar may ascertain whether “mycompany.com” has already been registered by checking the SRS database associated with the TLD of the domain name. The results of the search then may be displayed on the webpage to thereby notify the Internet user of the availability of the domain name. If the domain name is available, the Internet user may proceed with the registration process. Otherwise, the Internet user may keep selecting alternative domain names until an available domain name is found. Domain names are typically registered for a period of one to ten years with first rights to continually re-register the domain name.

The information on web pages is in the form of programmed source code that the browser interprets to determine what to display on the requesting device. The source code may include document formats, objects, parameters, positioning instructions, and other code that is defined in one or more web programming or markup languages. One web programming language is HyperText Markup Language (“HTML”), and all web pages use it to some extent. HTML uses text indicators called tags to provide interpretation instructions to the browser. The tags specify the composition of design elements such as text, images, shapes, hyperlinks to other web pages, programming objects such as JAVA applets, form fields, tables, and other elements. The web page can be formatted for proper display on computer systems with widely varying display parameters, due to differences in screen size, resolution, processing power, and maximum download speeds.

For Internet users and businesses alike, the Internet continues to be increasingly valuable. More people use the Web for everyday tasks, from social networking, shopping, banking, and paying bills to consuming media and entertainment. E-commerce is growing, with businesses delivering more services and content across the Internet, communicating and collaborating online, and inventing new ways to connect with each other. However, presently-existing systems and methods for designing and launching a website require a user wishing to establish an online presence to navigate through a complicated series of steps to do so. First, the owner must register a domain name. The owner must then design a website, or hire a website design company to design the website. Then, the owner must purchase, configure, and implement website-related services, including storage space and record configuration on a web server, software applications to add functionality to his website, maintenance and customer service plans, and the like. This process can be complicated, time-consuming, and fraught with opportunity for user error. It may also be very expensive to produce, serve, and maintain the user's website. Merchants may be hesitant to create an online presence because of the perceived effort involved to do so. These merchants limit their business to offline “brick and mortar” points of sale.

Some existing website design approaches can simplify the design process through automation of certain of the design process steps. Typically, a user is provided a template comprising a fully or substantially hard-coded framework. The user must then customize the framework by providing content, such as images, descriptive text, web page titles and internal organizational links between web pages, and element layout choices. While the resulting website may be customized to the user's preferences and may present the desired information, the design process remains complicated and time-consuming because the user must identify, locate, prepare, and upload all of the desired content and then organize it within the web pages of the website.

### BRIEF DESCRIPTION OF THE DRAWINGS

FIG. 1 is schematic diagram of a system and associated operating environment in accordance with the present disclosure.

FIG. 2 is a schematic illustration of a user interface for collecting seed input.

FIG. 3 is an illustration demonstrating a process of extracting keywords from a seed input image.

FIG. 4 is a flow diagram of a first embodiment of a method for generating websites from public, semi-private, and private data.

FIG. 5 is a schematic illustration of a user interface for identifying an entity associated with a user's input.

FIG. 6 is a diagram of an example categorization structure according to the present disclosure.

FIG. 7 is a diagram of a template according to the present disclosure.

FIGS. 8A-B are schematic illustrations of a sample website generated according to the present disclosure.

FIG. 9 is a flow diagram of a second embodiment of a method for generating websites from public, semi-private, and private data.

FIG. 10 is a flow diagram of a third embodiment of a method for generating websites from public, semi-private, and private data.

FIG. 11 is a schematic illustration of a confirmation page presented after publishing the website.

FIGS. 12A-C are schematic diagrams of a system for transmitting transaction data from a point-of-sale device to a web server.

FIG. 13 is a flow diagram of an embodiment of obtaining a seed input using offline crawling.

FIG. 14 is a flow diagram of a scripted decision tree for obtaining information from an offline resource.

FIG. 15 is a diagram of a user interface for entering information obtained from an offline resource.

FIG. 16 is a block diagram showing the functional components of a system for generating websites according to the present disclosure.

### DETAILED DESCRIPTION OF THE PREFERRED EMBODIMENT

The present invention overcomes the aforementioned drawbacks by providing a system and method for the creation of a website by automatically retrieving information from a number of data stores based on minimal identifying input related to an entity associated with the website, and generating a sample website that includes all or a portion of the information retrieved. The web server tasked with serving the web page to requesting devices, also known as a hosting provider, may perform one or more algorithms for the website creation. Alternatively, the web server may assign the creation to a related computer system, such as another web server, collection of web or other servers, a dedicated data processing computer, or another computer capable of performing the creation algorithms. Alternatively, a standalone program may be delivered to and installed on a personal computing device, such as the user's desktop computer or mobile device, and the standalone program may be configured to cause the personal computing device to perform the creation algorithms. For clarity of explanation, and not to limit the implementation of the present methods, the methods are described below as being performed by a web server that serves the web page to requesting devices. The creation of web pages is described with a left-sided prioritization for left-to-right reading countries; it will be understood that left and right directions may be reversed for right-to-left reading countries.

In one implementation, the present disclosure provides a method that includes obtaining, by a server computer communicatively coupled to an electronic network, a seed input, the seed input being associated with an entity. The seed input may include one or more keywords, such as a business name. Obtaining the seed input may include receiving the seed input from the user, or the seed input may be obtained without input from the user. Obtaining the seed input may include receiving, from a point-of-sale device in electronic communication with the server computer, transaction data for a transaction performed by the entity, and extracting the seed input from the transaction data. The method further includes using the seed input to identify the entity. Using the seed input to identify the entity may include performing one or more identification searches of one or more first data stores to obtain one or more entity candidates, storing the entity candidates in an entity candidate data store, and identifying one of the entity candidates as the entity. The seed input may include an image, and identifying the entity may include extracting one or more keywords from the image. The method further includes retrieving, by the server computer using at least one of the seed input and the identification of the entity, potential content relevant to the entity from one or more data stores. The method further includes generating, by the server computer without an input from the entity, a website for the entity, the website comprising at least a portion of the potential content. The method may further include offering, by the server computer, the website to the entity for purchase.

The method may further include using the seed input to categorize the entity according to a categorization structure. Retrieving the potential content may include using one or more categories relevant to the entity to identify the potential content. Generating the website may include using one or more categories relevant to the entity to identify a template for the website. The template may include a plurality of content regions, and generating the website may further include creating a plurality of content objects containing at least a portion of the potential content, and inserting one or more of the content objects into at least one of the content regions.

In another implementation, the present disclosure provides a method including generating, by a server computer communicatively coupled to an electronic network and without an input from a user, a website. The website includes content relevant to an entity retrieved from one or more first data stores. Generating the website may include automatically obtaining a seed input from one or more second data stores and retrieving, using the seed input, the content relevant to the entity from one or more of the first data stores. One or more of the second data stores may also be one of the first data stores. One or more of the second data stores may be selected from the group comprising a customer database of a website hosting provider, a business listings data store, and a government records data store. Generating the website may further include using the seed input to identify the entity. The method may further include offering the website to the user for purchase.

In another implementation, the present disclosure provides a method including generating, by a server computer communicatively coupled to an electronic network, a website for an entity, the website having a layout derived from a template that is relevant to a category of the entity, and a plurality of content regions arranged in the layout. Each content region has inserted content identified by the server computer as relevant to the entity. The inserted content is identified as relevant using a seed input that the server computer uses to identify the entity. The template may include a plurality of page layouts, and each of the page layouts may correspond to a web page that commonly appears on websites in the category. The inserted content of each of the content regions may have a particular type.

Generating the website may include: retrieving potential content from a plurality of data stores; identifying, from the potential content, the inserted content for each content region; and, for each content region, inserting the inserted content into the content region. The plurality of data stores may include a previous website for the entity, one or more social network presences, or one or more online business listings for the entity. Generating the website may further include associating a first of the content regions with a first of the data stores, and identifying the inserted content from the potential content may include identifying the inserted content of the first content region from the potential content retrieved from the first data store.

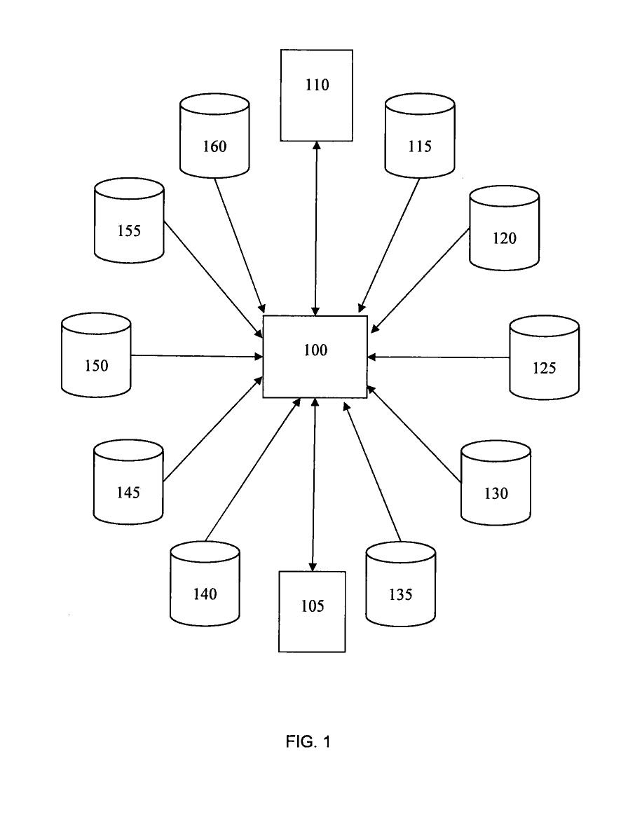

Referring to FIG. 1, a web server 100 may be configured to communicate over the Internet with one or more requesting device 110 in order to serve requested website content to the requesting device 110. The requesting devices 110 may request the website content using any electronic communication medium, communication protocol, and computer software suitable for transmission of data over the Internet. Examples include, respectively and without limitation: a wired connection, WiFi or other wireless network, cellular network, or satellite network; Transmission Control Protocol and Internet Protocol (“TCP/IP”), Global System for mobile Communications (“GSM”) protocols, code division multiple access (“CDMA”) protocols, and Long Term Evolution (“LTE”) mobile phone protocols; and web browsers such as MICROSOFT INTERNET EXPLORER, MOZILLA FIREFOX, and APPLE SAFARI.

A requesting device 110 may be a device for which web pages are typically designed without concern for display, user interface, processing, or Internet bandwidth limitations, including without limitation personal and workplace computing systems such as desktops, laptops, and thin clients, each with a monitor or built-in large display (collectively “PCs”). A requesting device 110 may be a device that cannot display the informational and functional content of web pages that are designed for viewing on PCs. Such limited devices include mobile devices such as mobile phones and tablet computers, and may further include other similarly limited devices for which conventional websites are not ordinarily designed. Mobile devices, and mobile phones in particular, have a significantly smaller display size than PCs, and may further have significantly less processing power and, if receiving data over a cellular network, significantly less Internet bandwidth.

The web server 100 may be configured to create a website that adapts to the requirements of requesting devices 110 with different capabilities as described above. In some embodiments, such adaptation may include generating a plurality of versions of the website that convey substantially the same content but are particularly formatted to be displayed on certain requesting devices 110, in certain browsers, or on certain domains (e.g. FACEBOOK or GOOGLE+). For example, the web server 100 may generate a first version of the website that is formatted for PCs, and a second version of the website that is formatted for display on mobile phones. In other embodiments, such adaptation may include converting a website from a format that can be displayed on one type of requesting device 110 into a website that can be displayed on another type of requesting device 110. For example, the web server 100 may, upon receiving a request for the website from a mobile phone, convert the website designed to be displayed on a PC into a format that can be displayed on the mobile phone. In the present disclosure, therefore, the term website refers to any public, private, or semi-private web property on which a user may maintain information and allow the information to be presented to the public or to a limited audience, and which is communicable via the Internet. Non-limiting examples of such web properties include websites, mobile websites, web pages within a larger website (e.g. profile pages on a social networking website), vertical information portals, distributed applications, and other organized data sources accessible by any device that may request data from a storage device (e.g., a client device in a client-server architecture), via a wired or wireless network connection, including, but not limited to, a desktop computer, mobile computer, telephone, or other wireless mobile device; content feeds and streams including RSS feeds, blogs and vlogs, YOUTUBE channels and other video streaming services, and the like; and downloadable digital platforms, such as electronic newsletters, blast emails, PDFs and other documents, programs, and the like.

The web server 100 may be configured to communicate electronically with one or more data stores in order to retrieve information from the data stores. The electronic communication may be over the Internet using any suitable electronic communication medium, communication protocol, and computer software including, without limitation: a wired connection, WiFi or other wireless network, cellular network, or satellite network; TCP/IP or another open or encrypted protocol; browser software, application programming interfaces, middleware, or dedicated software programs. The electronic communication may be over another type of network, such as an intranet or virtual private network, or may be via direct wired communication interfaces or any other suitable interface for transmitting data electronically from a data store to the web server 100. In some embodiments, a data store may be a component of the web server 100, such as by being contained in a memory module or on a disk drive of the web server 100.

A data store may be any repository of information that is or can be made freely or securely accessible by the web server 100. Suitable data stores include, without limitation: databases or database systems, which may be a local database, online database, desktop database, server-side database, relational database, hierarchical database, network database, object database, object-relational database, associative database, concept-oriented database, entity-attribute-value database, multi-dimensional database, semi-structured database, star schema database, XML database, file, collection of files, spreadsheet, or other means of data storage located on a computer, client, server, or any other storage device known in the art or developed in the future; file systems; and electronic files such as web pages, spreadsheets, and documents. Each data store accessible by the web server 100 may contain information that is relevant to the creation of the website, as described below. Such data stores include, without limitation to the illustrated examples: search engines 115; website information databases 120, such as domain registries, hosting service provider databases, website customer databases, and internet aggregation databases such as archive.org; government records databases 125, such as business entity registries maintained by a Secretary of State or corporation commission; public data aggregators 130, such as FACTUAL, ZABASEARCH, genealogical databases, and the like; social networking data stores 135, such as public, semi-private, or private information from FACEBOOK, TWITTER, FOURSQUARE, LINKEDIN, and the like; business listing data stores 140, such as YELP!, Yellow Pages, GOOGLE PLACES, LOCU, and the like; media-specific data stores 145, such as art museum databases, library databases, and the like; point-of-sale transaction data stores 150; offline crawling data stores 155; and entity candidate data stores 160 as described below.

To create its website, a user may access the web server 100 with the owner's device 105, which may be a PC, a mobile device, or another device able to connect electronically to the web server 100 over the Internet or another computer network. The user may be an individual, a group of individuals, a business or other organization, or any other entity that desires to build a website and use the website to convey information about itself or another topic, where the information may be of a commercial or a non-commercial nature. For clarity of explanation, and not to limit the implementation of the present methods, the methods are described below as being performed by a web server that receives input for creating a website for a small business, such as a restaurant or bar, retail store, or service provider (i.e. barber shop, real estate or insurance agent, repair shop, equipment renter, and the like), unless otherwise indicated.

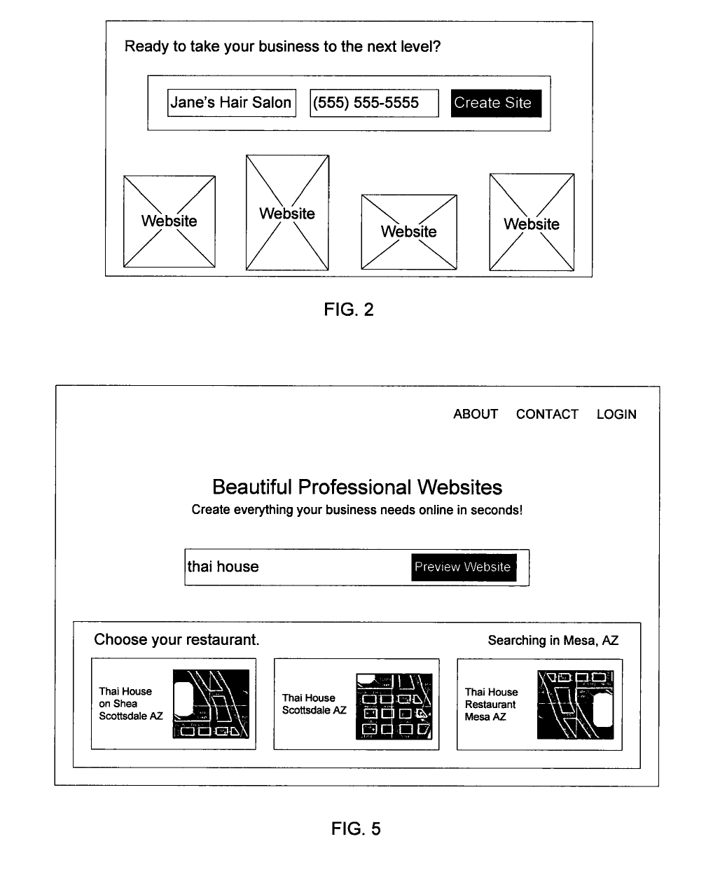

Referring to FIG. 2, the user may access the web server 100 through a user interface 200, which may be a web-based interface that the user accesses using a browser on the owner's device 105. The user interface 200 may include an input form in which the user enters a seed input. The web server 100 may use the seed input to perform the information retrieval and website generation algorithms described below. The seed input may be a data element that partially or fully identifies the user's business (that is, the entity requesting the creation of the website). The seed input may be one or more keywords including one or a combination of the following, for example and without limitation: part or all of the business name; part or all of the business address; the type of business, at a desired degree of specificity (i.e. “restaurant,” “Indian restaurant,” “North Indian restaurant,” “vegan North Indian restaurant,” etc.); part or all of the name of a person associated with the business, such as the owner or executive chef; part or all of the name of a relevant product produced or sold by the business; and any other text that may be used to identify the business. The seed input may be an image or video depicting, for example and without limitation: a part of the business, such as the storefront, interior, signage, or menu; trade dress, such as employee uniforms, vehicle decoration, and the like; one or more of the user's products or works of art; a person associated with the business, such as the owner or executive chef; and any other images that may be used to identify the business. The seed input may be an audio recording, such as a dictation of identifying information that may be converted into text, a musical or spoken word performance that identifies an artist associated with the business, or another audio recording that conveys identifying information about the business. The seed input may be a data set, such as a fingerprint or retina scan collected by an attached peripheral and identifying the user as either an individual or an owner of a business.

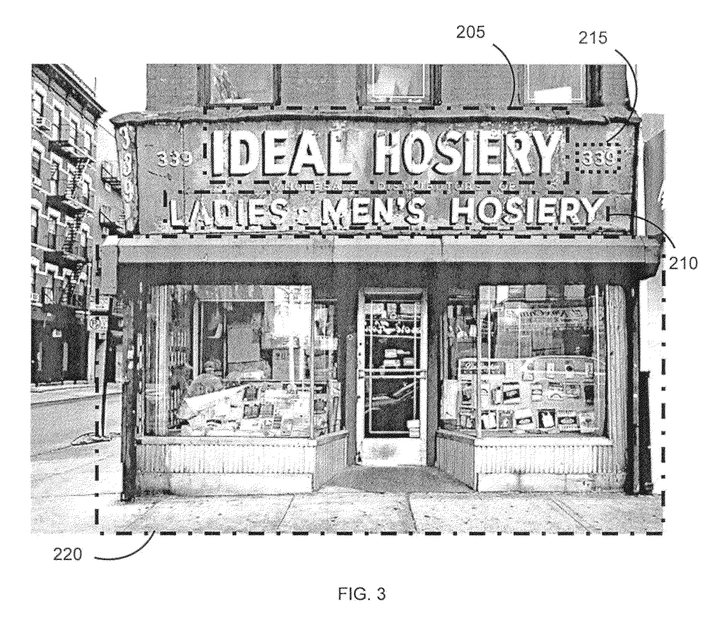

In some embodiments, the web server 100 may perform text and context analysis of an image or one or more frames of a video provided as seed input, in order to extract one or more keywords that may be used to perform identification or content searches as described below. Text analysis may include optical character recognition (“OCR”) or other text-identifying techniques, which extract words from the photograph. Context analysis may include relative comparison of identified text, such as text size and placement on a photographed sign, in order to identify relative importance of extracted keywords. FIG. 3 illustrates an example of processing a seed input image. Through OCR or another technique, three text strings 205, 210, 215 are identified in the image. Image processing techniques may identify a graphic region 220 that is compared to an image database to determine that the image depicts a storefront. Context analysis may arrange the identified text strings 205, 210, 215 in order of descending text size. The image being identified as a storefront, it may be assumed that at least the largest text string 205 appears on the signage. Further processing may ascertain the boundaries of the sign to determine if other text appears on the sign. The largest text string 205 is identified as the business name. The middle text string 210 may be compared to categories and keywords in the categorization structure described below to categorize the business. The smallest text string 215 contains only numbers and can be determined to be the street number in the business's address. This information may be used to further identify the business and to verify address information collected in the identification or content searches described below. Some or all of the text may be identified as keywords. In some embodiments, the web server 100 may transcribe an audio recording and perform pattern analysis on the transcription, the recording, or both. The web server 100 may identify heavily repeated words or words that are relatively heavily inflected as keywords.

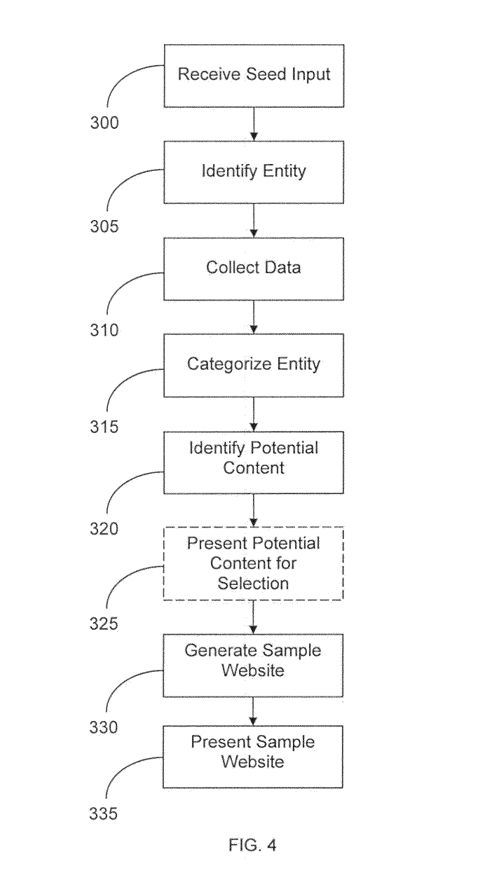

Referring to FIG. 4, at step 300, the web server 100 may receive the seed input from the user. At step 305, the web server 100 may use the seed input to identify the user or the entity represented by the user. The process of identifying the entity may depend on the type and scope of information provided as the seed input. If the seed input is a keyword or key phrase, the web server 100 may identify the entity by performing one or more identification searches of one or more of the data stores accessible by the web server 100. If the seed input is a media file, such as an image, video, audio recording, or another non-text input, the web server 100 may extract one or more keywords from the seed input as described above in order to perform the searches. Alternatively, an image, one or more frames of a video, or a clip of an audio recording may be directly compared to one or more records in a database of media of the same type as the seed input. For example, a photo of a work of art may be compared to images in a copyright database in the government records database 125, or to an art museum database, to identify the artist or the location of the work.

The identification searches may be limited to a geographic region. In some embodiments, the geographic region may be derived from keywords in the seed input. Alternatively or in addition, the geographic region may be derived from the IP address of the owner's device 105, which may geo-locate the user or the entity. Alternatively or in addition, where the seed input is a media file, the web server 100 may extract the location where the media file was recorded when such information is embedded in the media file. For example, an image captured with a smartphone may have embedded GPS data indicating the location of the smartphone when the photo was taken.

The identification searches may be limited to a particular type of business, which may be derived from keywords in the seed input. A keyword or key phrase may directly identify the business type (i.e. “restaurant,” “auto parts,” “chiropractic”) or suggest the business type (i.e. “diner,” “donuts,”), allowing the web server 100 to narrow the search without input from the user. The web server 100 may ignore a keyword for purposes of narrowing the identification searches by business type if the keyword is ambiguous (i.e. “clinic” could be a medical office or a mechanic, “spa” could be a massage parlor or a swimming pool store), or may query the user to clarify the business type. The business type derived from the seed input may correspond fully to one category, or partially to a plurality of categories, in the categorization structure described below. Such correspondence is not required, because the derived business type may simply be used to narrow the web server's 100 identification searches. However, if there is such a correspondence, the derived business type may be used to categorize the entity as described below with respect to step 315. Identification searches may additionally or alternatively be limited according to demographic or psychographic terms identified in the keywords, or by previous search keywords entered by the user or other users and stored by the web server 100.

The one or more identification searches may produce one or more search results from one or more of the searched data stores. The web server 100 may compile the search results in order to produce one or more entity candidates. Compiling the search results may include comparing results obtained from a data store and from different data stores to determine if multiple of the results pertain to the same entity. Comparing the results may include identifying common data elements and comparing the contents of the data elements. For example, the web server 100 may determine within each result one or more of a business name, address, phone number, and other common identifying data elements using field identifiers from a form or database, text formatting such as html tags and text size and justification comparisons, punctuation pattern comparisons, and the like. The web server 100 may extract such identifying data elements from the compiled search results and associate the identifying data elements with the entity candidates.

The web server 100 may evaluate the identified entity candidates according to a threshold confidence level, whereby the web server 100 ascertains the likelihood that the entity candidate is the user's entity. The entity candidates may be evaluated in an ordered list, the order determined by parameters from the search results. In one embodiment, the ordered list may correspond to the order in which the entity candidates appeared in search results from one or more of the data stores. For example, the web server 100 may perform an identification search by entering the keywords derived from the seed input into one or more of the popular search engines in the relevant geographic area (i.e. GOOGLE in the United States, GOOGLE.co.uk in the United Kingdom, BAIDU in China), and after compiling the search results and producing the entity candidates, the web server 100 may order the entity candidates according to the order in which they appeared in the search engine search results. In this manner, the most relevant search result from the search engine may be evaluated first. The web server 100 may obtain a confidence level as high as 100%, meaning an entity candidate is certain to correspond to the user's entity to the exclusion of the other entity candidates. In one embodiment, a confidence level of 100% may be attained by evaluating a single entity candidate. In this case, the seed input may include extensive identifying information, such as the business name and full address. The web server 100 compares the seed input to the data elements of the single entity candidate and finds a complete correlation, meaning all of the seed input is present in the data elements and no further identifying information is needed. In another embodiment, a confidence level of 100% may be attained by evaluating the first and second entity candidates in the ordered list. In this case, the web server 100 may determine that the seed input has significant correlation with the data elements of the first entity candidate, meaning most or all of the seed input is present in the data elements but more identifying information may be needed. The web server 100 may evaluate the second entity candidate and determine that there is low or no correlation between the seed input and the data elements, such that the threshold confidence level is not reached. The web server 100 may thus determine that evaluation of entity candidates lower in the ordered list is not needed, and the first entity candidate is certain to correspond to the user's entity.

The threshold confidence level may be fixed or variable. In some embodiments, a fixed threshold confidence level may be applied, whereby the web server 100 eliminates the entity candidates that do not meet the threshold, and retains the entity candidates that do meet the threshold. In some embodiments, an incrementally variable threshold confidence level may be applied, whereby the web server 100 eliminates entity candidates below a first threshold, then eliminates entity candidates below a second threshold higher than the first threshold, and so on until only the entity candidate or candidates above the most strict desired threshold confidence level remain. In some embodiments, a continuously variable threshold confidence level may be applied, wherein the threshold level is set to the confidence level of the evaluated entity candidate with the highest confidence level, and entity candidates with a lower confidence level are eliminated as the web server 100 processes them.

The web server's 100 evaluation of the entity candidates may identify a single entity candidate with a significantly higher confidence level than the other entity candidates. If this confidence level is sufficiently high, such as 80% confident, the web server 100 may identify the entity candidate as the user's entity. If there is not a single entity candidate with a significantly higher confidence level, the web server 100 may present the remaining entity candidates to the user so that the user may identify its entity from the shortened list of entity candidates. In the example user interface 200 of FIG. 5, the user entered “that house” as the seed input, and the web server 100 identified three candidate entities called That House but having different locations in the Metropolitan Phoenix, Ariz., area. Because the search was performed in Mesa, Ariz., the entity located in Mesa is presented in the middle of the three options, indicating it is most likely to be the correct entity. In this manner, the web server 100 may identify the user's entity based on minimal identifying input entered by the user.

Returning to FIG. 4, at step 310, the web server 100 may automatically collect, from one or more of the data stores, information comprising public, semi-private, or private data. The data may be collected by performing content searches of one or more of the data stores (e.g., the data stores shown in FIG. 1) using data elements pertaining to the identified entity as search terms. A plurality of content searches may be sequentially performed in the one or more data stores, with later-occurring content searches using data collected from previous content searches as additional or alternative search terms. The data may include data elements previously extracted from, or other data within, search results obtained in the identification searches described above. Semi-private and private data may be accessed by prompting the user for security credentials, such as a username and password for FACEBOOK, YELP, or other social networking websites. Alternatively, where the user is an account holder for services offered by the web server 100, the web server 100 may have stored access information or may have otherwise previously obtained authorization from the user to access such semi-private or private data, such as by using an open or delegated authorization standard.

The search results of the content searches may include raw data such as text, images, documents, and the like, data contained in structured or unstructured database records, data contained in one or more web pages, and other forms of structured or unstructured data. The web server 100 may collect the relevant data from the search results. Data may be identified as relevant based on one or a plurality of factors, including without limitation: currency of the data; size, including font size and image size; location within the source (i.e. placement on a web page); and, HTML tag information within the data, such as meta data or Microdata tags. In one implementation, the relevancy of data may be determined based upon a particular set of factors, such as name, address, geolocation and phone number. If these attributes are unavailable, other attributes can be employed to build a degree of confidence in the relevance of data. These factors can be, but are not limited to, User IP, image scanning, string matching, etc. Data is then standardized by data types such as name, address, location, phone number, Email, Social Handles, Operating Hours, and the like. Collecting the data may comprise scraping relevant data from the web pages using any known scraping technique. In some embodiments, one or more web pages identified in the identification or content searches and included in the collected data may be owned by the user. For example, the owner of That House may have had a previous website at www.thaihouse.com, which the web server 100 retrieves in its identification or content searches and scrapes to obtain the data that the user deemed relevant enough to include on his previous website.

At step 315, the web server 100 may automatically categorize the identified entity, which is used for performing certain aspects of the generation of the website as described below with respect to step 330. Alternatively, the web server 100 may display a list of categories to the user and allow the user to select the relevant categories pertaining to the identified entity.

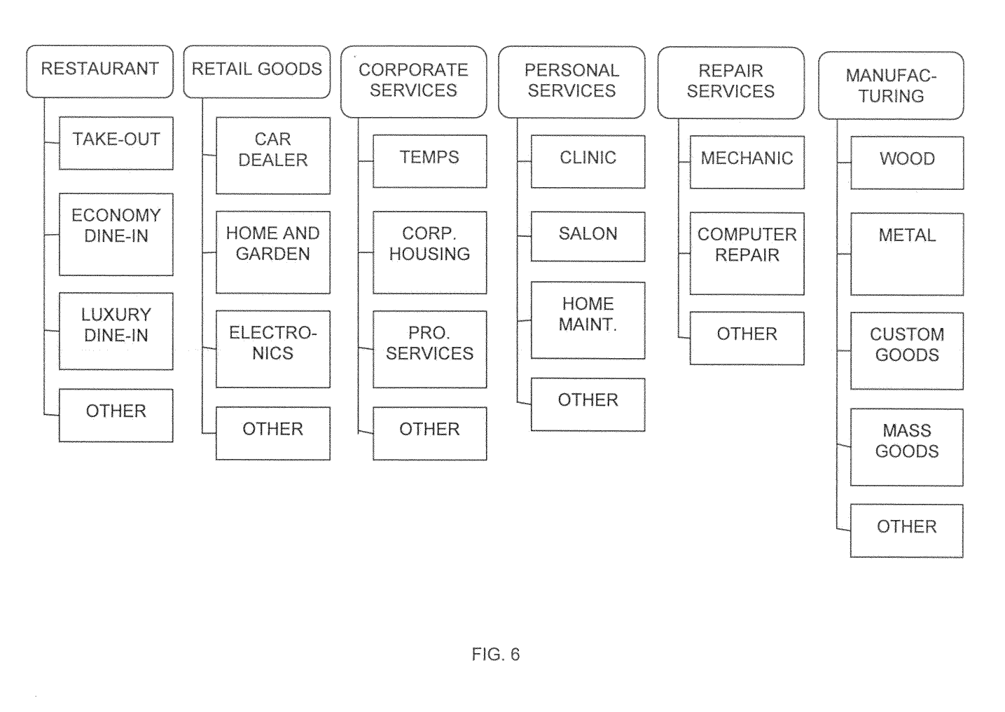

Categorization may be performed with respect to a categorization structure maintained by the web server 100. The categorization structure may include a list of categories and subcategories identifying types of entities according to the goods they manufacture or sell or the services they offer, the vertical market in which they compete, the type of customers they serve, one or more price points for their products, another suitable categorization methodology, or a combination of methodologies. The categorization structure may have any suitable structure, beginning at a suitably high level of abstraction and increasing in specificity correlative to nested subcategories. In one example, a single-level categorization structure includes the following broad categories relating to an entity's vertical market: restaurant; retail goods; corporate services; personal services; repair services; manufacturing; other. In another example, illustrated in FIG. 6, the single-level structure of the previous example has a second level of subcategories: restaurants includes take-out and delivery, economy dine-in, luxury dine-in, and other; retail goods includes car dealerships, home and garden goods, electronics, and other; corporate services includes temp agencies, corporate housing, professional services (i.e. corporate accountants, cleaning services), and other; personal services includes medical clinics, hair and nail salons, home maintenance (i.e. plumbers, landscapers, cleaners), and other; repair services includes mechanics, computer techs, and other; and manufacturing includes wood manufacturing, metal manufacturing, custom goods, large-scale goods, and other).

The web server 100 may use data collected in step 310, search results from the identification searches, keywords from the seed input, or a combination thereof, to determine one or more proper categories (e.g., the proper vertical market) for the identified entity. The web server 100 may search any of these data sources for occurrences of a category title. The categorization structure may further include one or more additional keywords associated with each category, which the web server 100 may further use to search the data sources for occurrences thereof. The web server 100 may perform a term frequency analysis or any other suitable analysis to determine the proper categories for the identified entity.

At step 320, the web server 100 may identify potential content for the generated website within the data collected in step 310. In some embodiments, all of the collected data may be potential content. In other embodiments, the collected data may include information that, while related to the identified entity, may not be useful as website content. For example, entity information from a Secretary of State database may not convey information about the entity's goods or services and therefore may not be included on a website displayed to potential customers. The web server 100 may identify potential content by analyzing the collected data in light of the one or more categories.

In some embodiments, the web server 100 may utilize a content framework that describes data elements that commonly appear as website content for each category of business. The content framework may include parameters or filters such as keywords, data structures, identifiers for HTML forms, tables, or other website elements, and the like, which the web server 100 may compare to collected data to determine if the data is suitable content to be incorporated into the website. The content framework may be expressed as a series of regular expressions and can be used to analyze the potential content, identify portions of the same that may be incorporated into the website, and also to tag the identified portions so that they can be incorporated into the website in an appropriate location with suitable formatting. For example, if a particular portion of the potential content is identified, through the use of the content framework as “about us” data, that data can then be incorporated into the “about us” section of the webpage. Similarly, if a portion of the potential content is identified by the content framework as a business address, that information can then be used to display a map on the website that depicts the location of the address.

The content framework may include parameters that apply to all categories, parameters that apply to a subset of categories, parameters that apply to a single category including or excluding its subcategories, and parameters that apply only to one or more subcategories. Non-limiting examples of parameters that apply to all categories include entity name, address, phone number, and email address. Non-limiting examples of parameters that apply to a subset of categories include business hours, customer reviews or testimonials, social media mentions, brand-relevant images, promotions, locations, service lists, and price lists. Non-limiting examples of parameters that apply to a single category or sub-category include menus (to restaurants, including bars), images of hair cuts (to hair salons), and the like. The web server 100, informed by the content framework, may create content objects by grouping, arranging, and classifying the data elements in the potential content according to the content framework parameters by which the data elements were identified as potential content. For example, the web server 100 may obtain a restaurant's menu by identifying a web page, on the restaurant's existing website, that has the word “menu” in the title. The web server 100 may collect all of the data elements within certain HTML tags, such as paragraph tags, on the “menu” web page, identify the name, price, and description of each menu item, arrange the menu items in an ordered list, and classify the ordered list as “menu.” The web server 100 may also classify the content by identifying a series of like-sized images clustered adjacent to each other and convert them into a slideshow. The webserver 100 may also identify the highest density keywords or keyphrases associated with particular sets of content in one or more categories and optimize the title and description tag of webpages that are associated with the same search term.

At optional step 325, the web server 100 may present the potential content to the user in the user interface 200, and allow the user to select which content to include in the website. The web server 100 may filter any unselected content out of the potential content. The web server 100 may further collect input from the user which the user wants to include on the website. The web server 100 may incorporate the provided input into the potential content.

At step 330, the web server 100 may generate a sample website having a layout and the potential content arranged within the layout. The layout may be derived from a website template stored in the content framework, or stored in a template database and identified by the content framework. The content framework or template database may include a plurality of templates. A template may include one or more web pages and one or more content regions on each of the web pages. Each content region may describe a position and area on a web page. Each content region may identify the potential content, such as an image, text, or one or more content objects, that is to be inserted into the content region. The web server 100 thereby may generate a website that displays the inserted content at the content region's location on the web page. The arrangement of content regions and selection of content to be displayed therein may be designed according to one or more categories associated with the template. Specifically, where the web server 100 has identified the potential content in light of the entity's categories, the one or more templates associated with the relevant categories include web pages and frames that arrange and present the appropriate potential content.

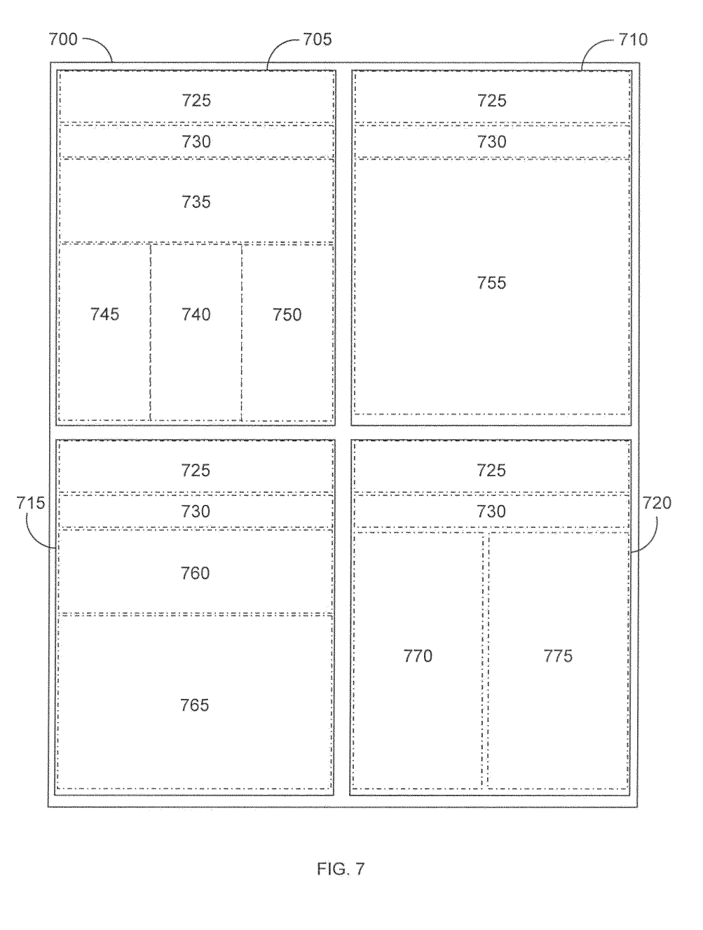

FIG. 7 illustrates an example template 700 for a sample website in the restaurant category. The template 700 includes page layouts 705-720 for a plurality of web pages that commonly appear on a restaurant website: a “home” page layout 705 for displaying basic information; a “menu” page layout 710 for displaying the menu; an “about” page layout 715 for displaying restaurant background, such as history of the restaurant or biographies of the owners or chef; and a “contact” page layout 720 for displaying addresses, phone numbers, driving directions, email feedback forms, and the like. Each page layout 705-720 includes one or more content regions 725-775 for receiving and displaying one or more content objects and, optionally, additional content. Each content region 725-775 may be associated with a particular type of content or data (for example, as identified by the parameters of the content framework) in the potential content. To the extent particular data stores or data sources are likely to contain suitable data or content for a particular content region (e.g., a data store that includes only text may not be a suitable data source for content to populate a content region that calls for an image), the content regions may be associated with one or more particular data source. The associated data sources may further be prioritized to instruct the web server 100 of a preferred order in which to search the potential content retrieved from the prioritized data sources. In one embodiment, the content framework may store the associations between the content regions 725-775 and the data sources. In another embodiment, the associations may be stored in the template.

In the illustrated example template 700, each page layout 705-720 includes a masthead region 725 and a navigation region 730 as common content across all web pages. The masthead region 725 may display the entity's name, logo, other graphics, or a combination thereof. The web server 100 may first attempt to populate the masthead region 725 with content from the identification searches, followed by content from the user's previous website, extracted from the search engines 115. The navigation region 730 may display internal links to other web pages in the website. The home page layout 705 further contains a main graphic region 735, an attraction region 740, a location region 745, and a new region 750. The main graphic region 735 displays a relevant and eye-catching graphic, such as a photo of the storefront or of a dish served at the restaurant. The web server 100 may first attempt to populate the main graphic region 735 with content from the user's previous website, extracted from the search engines 115, followed by content from the user's social network presences, such as FACEBOOK, FLICKR, and TWITTER, in that order, and finally followed by content from the user's business listings 140, if any. If no suitable content is identified, the web server 100 may identify and insert a stock image. The attraction region 740 displays relevant and eye-catching text information, such as the restaurant's specials. The web server 100 may first attempt to populate the attraction region 740 with content from the user's social network presences, such as FACEBOOK and TWITTER, in that order, followed by content from the user's previous website, extracted from the search engines 115, followed by and finally followed by content from the user's business listings 140, if any. The location region 745 displays important contact information, such as a map locating the restaurant and the restaurant's address and phone number, and may be populated with content from the identification searches first, followed by content from the user's previous website, and then by content from the user's business listings 140. The new region 750 displays recent information published about the restaurant, such as TWITTER or blog posts or press releases, and may be populated with content from the user's social network presences, such as FACEBOOK and TWITTER, first, followed by content from the user's previous website, and then by other content retrieved from the search engines 115.

The menu page layout 710 may further include a menu region 755 for displaying the restaurant's menu. The web server 100 may first attempt to populate the menu region 755 with content from the user's previous website, extracted from the search engines 115, followed by content from the user's business listings 140, such as LOCU and YELP, in that order, and followed by content from the user's social network presences. The about page layout 715 may further include a bio image region 760 and a biography region 765. The bio image region 760 displays a relevant graphic, such as a photo of the storefront or restaurant owners, and may be populated with content from the user's previous website, extracted from the search engines 115, followed by content from the user's social network presences, such as FACEBOOK, FLICKR, and TWITTER, in that order, and finally followed by content from the user's business listings 140, if any. If no suitable content is identified, the web server 100 may identify and insert a stock image. The biography region 765 displays a narrative regarding the restaurant and its owners and may be populated with content from the user's previous website, extracted from the search engines 115, followed by content from the user's social network presences, such as FACEBOOK, FLICKR, and TWITTER, in that order, and finally followed by content from the user's business listings 140, if any. The contact page layout 720 may further include an info region 770 and a feedback region 775. The info region 770 displays contact information, such as phone number, address, map, and the like, and may be populated with content from the identification searches, followed by content from the search engines 115, and followed by content from the government records databases 125. The feedback region 775 displays a form for website visitors to fill out and submit to the restaurant. The form structure may be stored in the template, with the submission information, such as email address for delivering the form data, being extracted from a website customer database or the user's previous website.

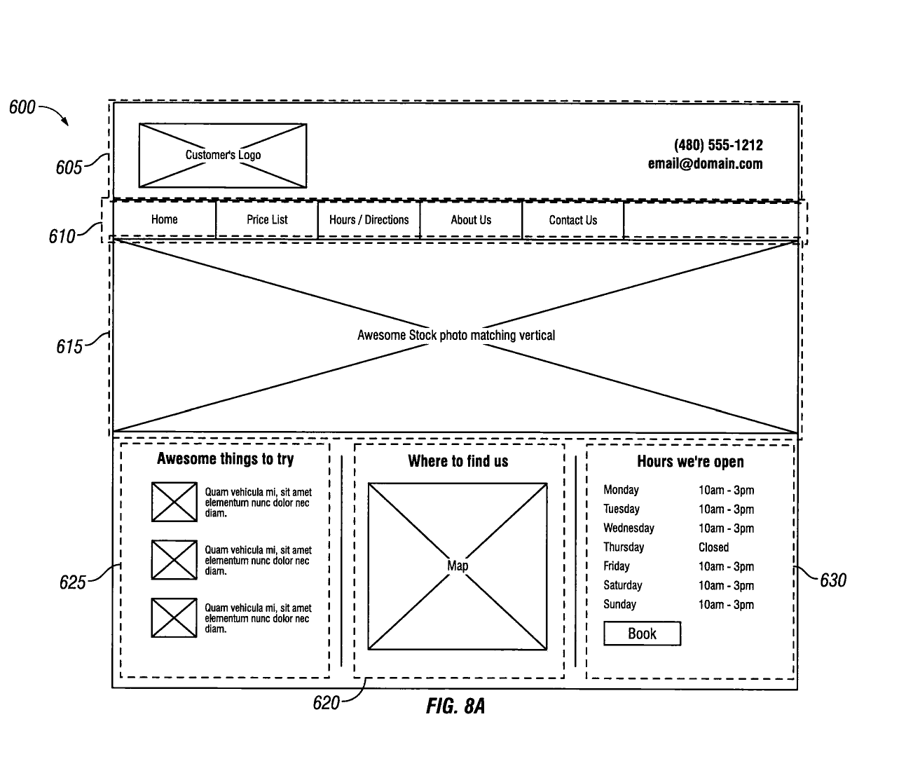

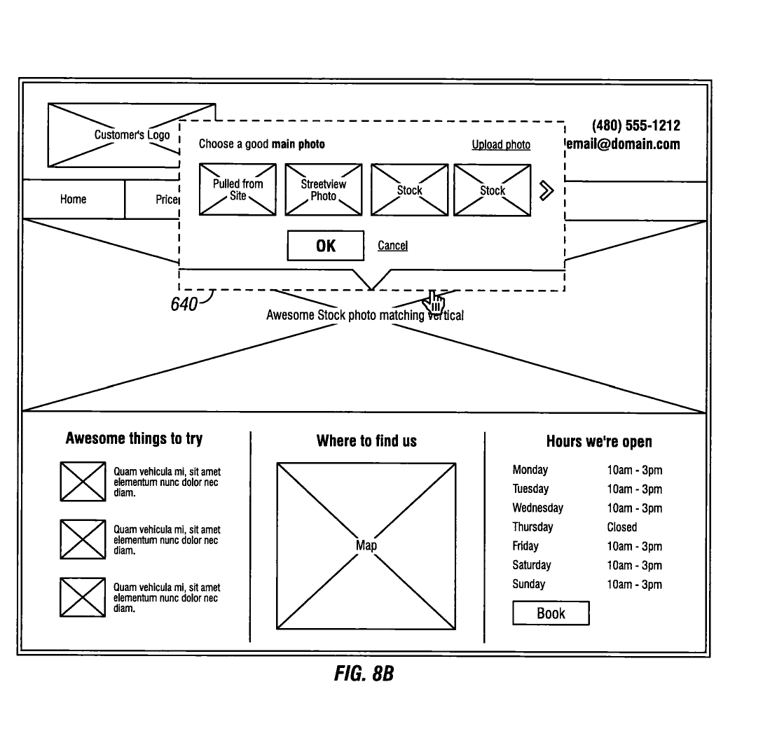

FIGS. 8A and 8B illustrate an example sample website 600 generated using the template 700 of FIG. 7. The illustrated home page contains the following content objects: a masthead 605 containing one or more of the entity name, logo, and primary contact information; a navigation interface 610 providing links to the other web pages of the website; a main graphic 615 such as an image of tasty food or other attractive graphic design; a map container 620; news 625 including promotions or highlights of the entity's product offerings; and hours of operaiton 630. The web server 100 may complete the generation of the sample website 600 automatically by selecting content for any placeholders in the sample website 600 layout (e.g., by selecting a stock photo for the main graphic 615 of FIG. 8A). Additionally or alternatively, the web server 100 may provide, through the interface, options to the user for modifying the content. For example, the web server 100 may present a popup 640 for the main graphic 615 as shown in FIG. 8B, and the popup 640 may include potential photographs to be selected, or a “browse” or “upload” button for the user to provide his own image file.

Returning to FIG. 4, at step 335, the web server 100 may present the generated sample website to the user. The web server 100 may present the user with an option to purchase the sample website as-is, or to modify the layout or content of the sample website. If the user chooses to modify the layout or content of the sample website, the web server 100 may return to step 325 or may present a website editor in the user interface 200, the website editor allowing the user to manually change the sample website. If the user chooses to purchase the sample website, the web server 100 may process a purchase transaction, and may further offer additional services to the user, such as domain registration services or website hosting services.

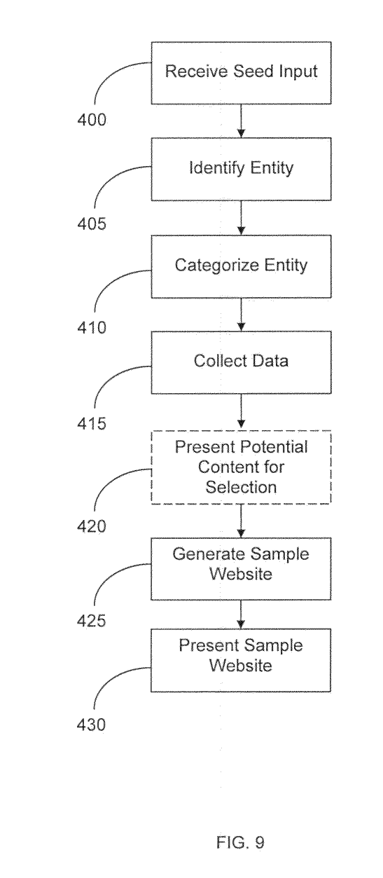

In some embodiments, the web server 100 may generate the website, such as the sample website 600 of FIG. 8, according to the method illustrated in FIG. 9. At step 400, the web server 100 may receive the seed input as described with respect to step 300 of FIG. 4. At step 405, the web server 100 may identify the entity as described with respect to step 305 of FIG. 4. At step 410, the web server 100 may automatically categorize the identified entity. Alternatively, the web server 100 may display a list of categories to the user and allow the user to select the relevant categories pertaining to the identified entity. Categorization may be performed with respect to a categorization structure maintained by the web server 100. The categorization structure may include a list of categories and subcategories identifying types of entities according to the goods they manufacture or sell or the services they offer. The categorization structure may have any suitable structure, beginning at a suitably high level of abstraction and increasing in specificity correlative to nested subcategories. In one example, a single-level categorization structure includes the following broad categories: restaurant; retail goods; corporate services; personal services; repair services; manufacturing; other. In another example, the single-level structure of the previous example has a second level of subcategories: restaurants includes take-out and delivery, economy dine-in, luxury dine-in, and other; retail goods includes car dealerships, home and garden goods, electronics, and other; corporate services includes temp agencies, corporate housing, professional services (i.e. corporate accountants, cleaning services), and other; personal services includes medical clinics, hair and nail salons, home maintenance (i.e. plumbers, landscapers, cleaners), and other; repair services includes mechanics, computer techs, and other; and manufacturing includes wood manufacturing, metal manufacturing, custom goods, large-scale goods, and other).

The web server 100 may use search results from the identification searches, keywords from the seed input, other input from the user, or a combination thereof, to determine one or more proper categories for the identified entity. The web server 100 may search any of these data sources for occurrences of a category title. The categorization structure may further include one or more additional keywords associated with each category, which the web server 100 may further use to search the data sources for occurrences thereof. The web server 100 may perform a term frequency analysis or any other suitable analysis to determine the proper categories for the identified entity.

At step 415, the web server 100 may automatically collect, from one or more of the data stores, information comprising public, semi-private, or private data. The data may be collected by performing content searches of the data stores using data elements pertaining to the identified entity as search terms. A plurality of content searches may be sequentially performed, with later-occurring content searches using data collected from previous content searches as additional or alternative search terms. Semi-private and private data may be accessed by prompting the user for security credentials, such as a username and password for FACEBOOK, YELP, or other social networking websites. Alternatively, where the user is an account holder for services offered by the web server 100, the web server 100 may have stored access information or may have otherwise previously obtained authorization from the user to access such semi-private or private data.

The web server 100 may use the categories identified in step 410 as relevant to the entity in order to limit the collected data to only data that is potential content for the generated website. In some embodiments, the web server 100 may utilize a content framework that specifies data elements that commonly appear as website content for each category of business. The content framework may include parameters such as keywords, data structures, identifiers for HTML forms, tables, or other website elements, and the like. The content framework may include parameters that apply to all categories, parameters that apply to a subset of categories, parameters that apply to a single category including or excluding its subcategories, and parameters that apply only to one or more subcategories. The web server 100, informed by the content framework, may compare data from the data stores to one or more such parameters, and may thereby collect only data that pertains to the relevant parameters of the content framework. Collecting the data may comprise one or more data search and retrieval techniques, including scraping relevant data from web pages using any known scraping technique. The data may include data elements previously extracted from, or other data within, search results obtained in the identification searches described above. The search results of the content searches may include raw data such as text, images, documents, and the like, data contained in structured or unstructured database records, data contained in one or more web pages, and other forms of structured or unstructured data. All or substantially all of the data in the search results may be potential content for the generated website.

At optional step 420, the web server 100 may present the potential content to the user in the user interface 200, and allow the user to select which content to include in the website, as described with respect to step 325 of FIG. 4. At step 425, the web server 100 may generate a sample website as described with respect to step 330 of FIG. 4 and FIG. 8. At step 430, the web server 100 may present the sample website to the user as described with respect to step 335 of FIG. 4.

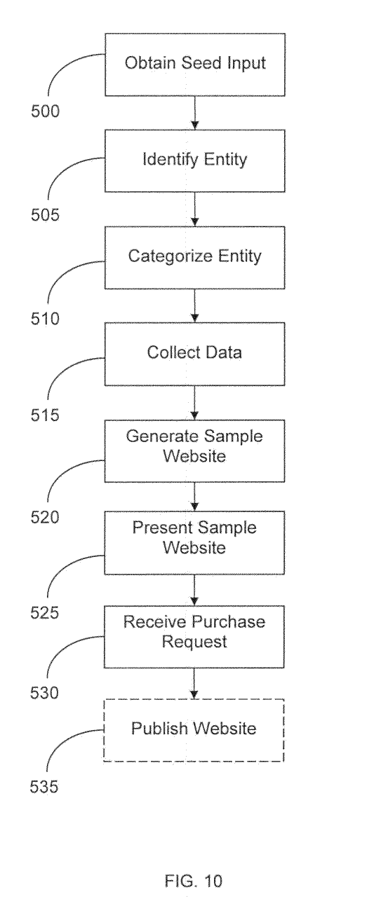

In some embodiments, the web server 100 may generate the website, such as the sample website 600 of FIG. 8, according to the method illustrated in FIG. 10. At step 500, the web server 100 may obtain the seed input without an input from the user. Obtaining the seed input may be automated, and may, in some embodiments, be verified by manual review. The seed input may be obtained contemporaneously with the other steps of generating the website (i.e., upon obtaining the seed input at step 500, the web server 100 may proceed substantially immediately to the next step 505). Alternatively, the seed input may be obtained at a substantially earlier time (i.e., minutes, hours, weeks, etc.) before the web server 100 executes the subsequent website generation steps. Where the seed input is obtained substantially in advance of the subsequent steps, the seed input may be stored by the web server 100 for later retrieval.

In some embodiments, the web server 100 may obtain the seed input by automatically searching one or more of the data stores 115-160. In some embodiments, the web server 100 may be triggered by occurrence of an event to identify and obtain the seed input. For example, upon receiving notice that a domain name has been registered, or a domain name registration has expired, or a website customer whose information is stored in a website information database 120 updates or deletes its website, the web server 100 may collect keywords from the notice or perform additional searching to obtain keywords, the keywords being usable as seed input. As a further example, if the web server 100 is or is owned by a website hosting provider, the web server 100 may search its own customer database to obtain the seed input. In other embodiments, the web server 100 may periodically perform searches of one or more of the data stores 115-160 to ascertain if new information is available, the new information indicating that an entity may be interested in obtaining a new website. For example, the web server 100 may periodically collect information about new entity filings from a government records database 125, or new entries in the entity candidate data store 160 or in one or more business listings 140, and use the information, such as the new entities' names, as the seed input.

At step 505, the web server 100 may identify the entity as described with respect to step 305 of FIG. 4. Additionally or alternatively, the entity candidates may be stored in an entity candidate data store 160, which may be a database containing structured data records for each entity candidate. In some embodiments, the web server 100 may collect the entity candidates, periodically or upon occurrence of an event. The entity candidates may thereby be obtained by the web server 100 well in advance of generating the website. In this manner, the entity candidate data store 160 may store structured identifying information for a plurality of entities identified by the system as described herein. In some embodiments, the web server 100 may perform the subsequent website generation steps for some or all of the entity candidates without receiving any input from a user. In other embodiments, the web server 100 may receive from a user an entity-identifying input, such as a business name or address as described above, and may match the input to an entity in the entity candidate data store 160 according to the methods of step 305 of FIG. 4.

At step 510, the web server 100 may automatically categorize the identified entity as described with respect to step 410 of FIG. 9. At step 515, the web server 100 may automatically collect, from one or more of the data stores, information comprising public, semi-private, or private data, as described with respect to step 415 of FIG. 9. At step 520, the web server 100 may generate a sample website as described with respect to step 330 of FIG. 4 and FIG. 8. At step 525, the web server 100 may present the sample website to the entity, which may be a user as used herein or a person or entity related to the identified entity whose contact information the web server 100 has obtained by performing the identification or content searches. At step 530, the web server 100 may receive a request from the contacted person or entity to purchase the sample website.

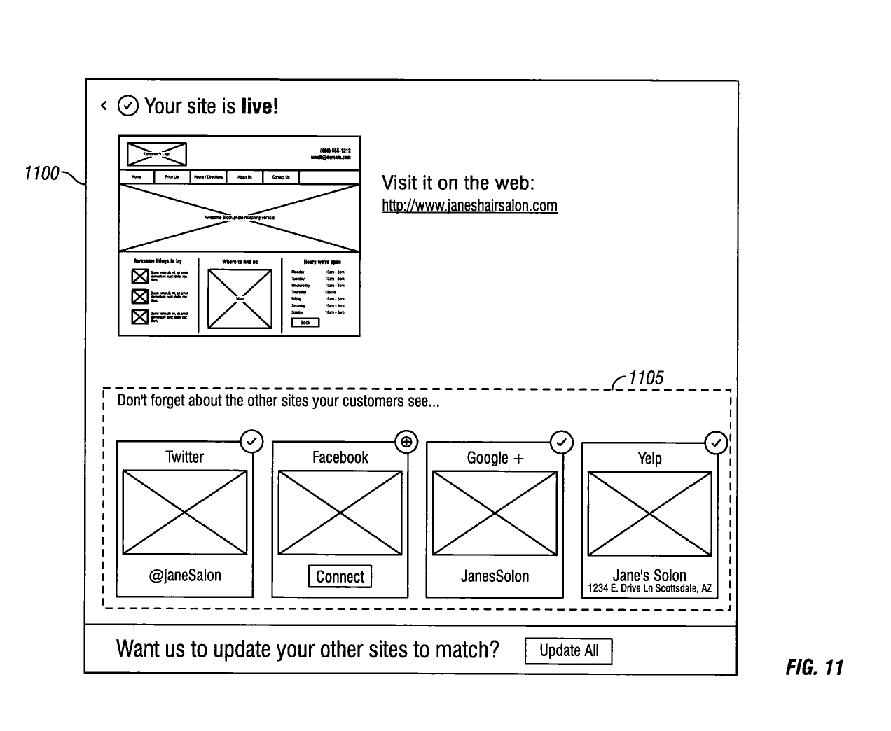

At step 535, the web server 100 may publish the website to its platform. Publishing the website may include providing to the user a confirmation that the website has been published. Referring to FIG. 11, a confirmation page 1100 presented to the user via the interface may include a distribution widget 1105 that allows the user to quickly publish some or all of the newly published content to other platforms. For example, as illustrated, the web server 100 had generated a website for display at a URL, www.janeshairsalon.com, owned or operated by the entity, and the web server 100 presents the widget 1105 to the entity for publishing to its social media platforms. In the example widget 1105, the web server 100 has already connected to the entity's TWITTER, GOOGLE+, and YELP accounts using the methods described above. The entity can click on one of the connected platforms to publish the new content there. The widget 1105 also offers the entity the option to connect additional platforms, for example FACEBOOK as illustrated.

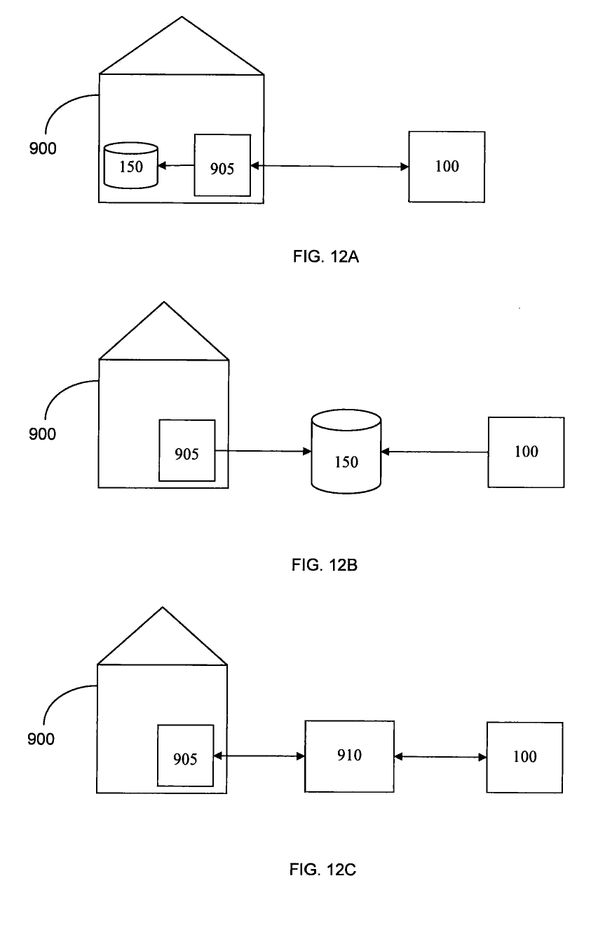

Referring to FIGS. 12A-C, the seed input may be received, as in steps 300 or 400, or obtained, as in step 500, from a point-of-sale (POS) device 905 that may be located in or tied to a physical store 900. The POS device 905 may be any device that produces data related to an exchange of goods or services for payment (i.e., a “transaction”). Suitable POS devices 905 include, without limitation, credit or debit payment terminals, smart card readers, smart registers, mobile device payment terminals and interface modules, receipt printers, and other devices at the point-of-sale that use transaction data. The transaction data can be produced via typical payment instrument processing, wherein the customer “swipes” a credit card or pays with an e-check or other electronic instrument to initiate compilation of the transaction data, which is sent by the POS device 905 to a payment processor for approval. Alternatively, the POS device 905 can be modified with a hardware or software module to produce transaction data for some or all transactions, including transactions that typically do not produce it, such as cash payments, locally-stored-value gift cards (i.e., on-card magnetic storage), and the like.

In some embodiments, some or all of the transaction data may be merchant- or customer-sensitive information. The present systems and methods may implement encryption, secured-account access, and other safeguards, and further may cooperate with one or more external security measures, to protect the confidentiality of such information. The entity may have a secured account on or accessible by the web server 100, or may be prompted to create such an account when the transaction data is first transmitted to or received by the web server 100. Additionally or alternatively, the POS device 905 (or the hardware or software module(s) implemented thereon for performing the described methods) may be configured to request, from the merchant, the customer, or both, permission to use the transaction data in the methods described herein.

The transaction data may include information that the presently-described systems may be configured to use as seed input. For example, the transaction data may include the business name, physical or electronic address, or phone number, account numbers that may be associated with the business if authorization to use them is obtained, IP address of the POS device 905 if it is connected to the Internet, descriptive terms related to the goods or services sold, or any combination of such information. The transaction data may further include information that may suitably be displayed as content on the website, including by non-limiting example: one or more identifiers of the products sold, such as the product name, stock-keeping unit (SKU), product number, or other identifier; the quantity of each product sold; the price of products sold; the date and time of the transaction; information regarding promotions applied; and customer identifiers, such as an account number or username.

The seed input may be obtained from the transaction data of a single transaction or of multiple transactions. In one example, where transaction data for each transaction does not include a clear identifier (e.g. a business name or address), information about products sold across multiple transactions may be compiled to produce a seed input that includes keywords representing the types of goods or services sold. Furthermore, transaction data from multiple transactions may be compiled and analyzed to determine other information about the entity that may be included on the website. Non-limiting examples include: earliest and latest transaction times on each day may indicate hours of operation; transaction or customer addresses may indicate a delivery area; varying costs of the same service may determine a cost estimate range; quantities of products sold may identify most popular products, which can then be emphasized on the website; types of products sold can identify the entity's vertical market, competitors, and the like; coupon application frequency can provide marketing metrics; and transaction frequency can identify repeat customers or busiest/slowest times of day.

According to the above descriptions of using POS transaction data to generate one or more web pages in the website, the web page content generation methods may be used to maintain comprehensive transaction information for both online and offline transactions for the identified entity. In some embodiments, the web server 100 may obtain the online transaction information from online data stores, and the offline transaction information from one or more POSs or other offline data sources. Online data stores may include, for example, databases maintained by an e-commerce website run by the entity or by an online reseller (e.g., AMAZON). The online and offline transaction information may be compiled to generate comprehensive transaction information, including without limitation: total quantity of a product sold; price range over which product is sold; sale patterns such as frequency of purchase per day or per location, online versus offline purchases, items commonly purchased together, and items and quantity thereof typically sold by a particular salesperson or purchased by a particular customer; and other comprehensive information. Such comprehensive information may include any transaction-related information suitable for displaying on an e-commerce website and may be used to generate one or more e-commerce web pages for the website. E-commerce web pages may include an online store as is known in the art, being further configured to include product information for products that are available offline as well as online. The comprehensive information may be formatted for display on the e-commerce web pages according to the embodiments described above.

Referring to FIG. 12A, the web server 100 may communicate directly with the POS device 905 to receive or obtain all or a portion of the transaction data for one or more transactions, which the POS device 905 stores and/or maintains in the POS transaction data store 150. The POS device 905 may thus be communicatively connected to the Internet or another computer, satellite, or cellular network to which the web server 100 is also connected. In some embodiments, the POS device 905 may transmit the transaction data to the web server 100, which receives the seed input as in steps 300 or 400 by extracting it from the transaction data using any of the data analysis methods described above. The transmission may take place upon completion of the transaction, or the transaction data for one or more transactions may be transmitted at a predetermined interval, such as hourly or daily. In other embodiments, the web server 100 may obtain the seed input as in step 500 by transmitting a request for the transaction data to the POS device 905 over the network. Where the transaction data received on the web server 100 includes information suitable as web page content, the web server 100 may also extract such information. The transaction data may be raw data generated by the POS device 905, which the web server 100 may be configured to interpret. For example, the web server 100 may be configured to extract clearly identifiable data from the raw transaction data, such as the business name and address. The web server 100 may also have access to one or more data stores containing information that allows the web server 100 to associate transaction data, such as account numbers and other identifiers, with the business. In other embodiments, the POS device 905 may be configured to provide formatted transaction data, such as in an XML file or spreadsheet, to the web server 100.

Referring to FIG. 12B, the web server 100 and POS device 905 may each have electronic access to the POS transaction data store 150, which may be remote from both devices and stored on another server, in a cloud storage infrastructure, or in another suitable storage arrangement. The POS device 905 may, periodically or upon completion of a transaction, transmit the transaction data to the transaction data store 150 for storage. The web server 100 may then retrieve the transaction data from the transaction data store 150 and obtain the seed input, as in step 500, and any other useful information from the transaction data as described above.

Referring to FIG. 12C, the web server 100 and POS device 905 may be in electronic communication with a transaction recording device 910 that acquires the transaction data from the POS device 905 and transmits it to the web server 100. The transaction recording device 910 may be a hardware- or software-implemented module, and may be resident on or in physical approximation to the POS device 905, or may be remote from both the POS device 905 and the web server 100. In some embodiments, the transaction recording device 910 may receive the transaction data from the POS device 905 via a direct transmission. That is, the POS device 905 may be configured to send the transaction data directly to the transaction recording device 910 periodically or when a transaction is completed. In other embodiments, the transaction recording device 910 may obtain the transaction data by indirect transmission. For example, the transaction recording device 910 may be configured to monitor transmissions from the POS device 905 to the POS transaction data store 150, another data store, or another device within a trusted network of devices to which the POS device 905 is connected. By monitoring such transmissions, the transaction recording device 910 may acquire the transaction data from the transmission as it takes place. In another example, the transaction recording device 910 may monitor transmissions from the POS device 905 to a transaction processor, such as a financial institution or credit card transaction processor. In this manner, the transaction recording device 910 may obtain the transaction data during the transaction, when such data is sent to the transaction processor for the payment instrument the current customer is using. Upon obtaining the transaction data, the transaction recording device 910 may transmit all or part of the transaction data to the web server 100. The transaction recording device 910 may then delete the transaction data or store it in the POS transaction data store 150 or another data store. The web server 100 may then retrieve the transaction data from the transaction data store 150 and obtain the seed input, as in step 500, and any other useful information from the transaction data as described above.

In various embodiments, the systems and methods described herein may support “offline crawling” to acquire the seed input, and optionally other information suitable for presentation on the internet, from resources that are not provided by a merchant, and are not available for discovery on the Internet or any other computer network. Offline crawling refers to identification of an offline resource, non-electronic acquisition of information from that offline resource, and electronic or non-electronic analysis of such information. Offline crawling can be performed in order to identify an entity, or to obtain additional information relating to an identified entity. In any case, the goal of offline crawling is to digitize information that the web server 100 could not previously access electronically.

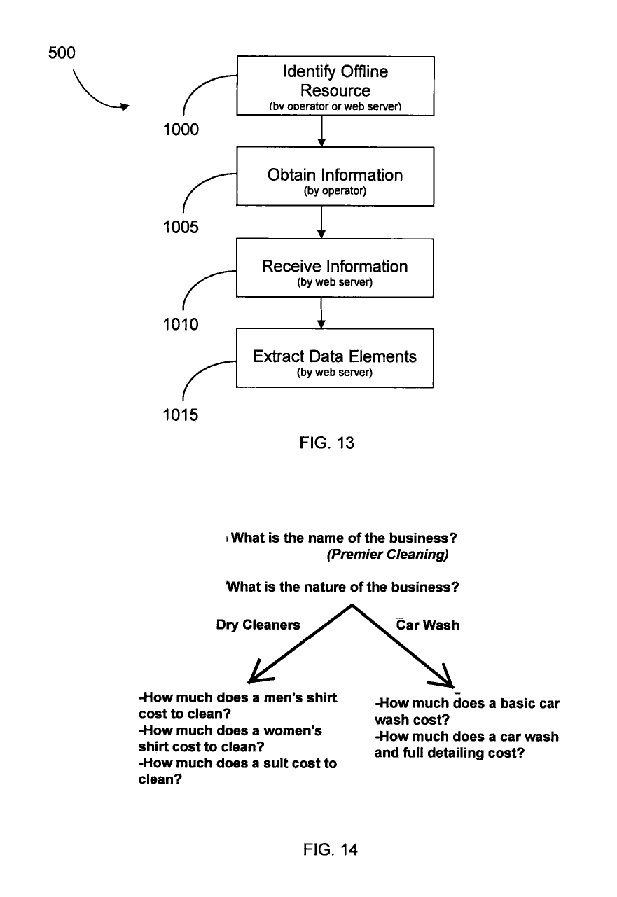

Referring to FIG. 13, obtaining the seed input may include, at step 1000, identifying an offline resource. An offline resource may be a physical building, printed document, telephone or fax number, billboard or other advertising display, television or radio broadcast, vehicle, product package, and the like, or an employee, customer or other relevant person. At this step, the entity associated with the offline resource may or may not be known, i.e., the subsequent steps of the present method may identify the entity using information from the offline resource as seed input.

Although the resource itself is offline, the resource may be identified from information found on the Internet. In some embodiments, the web server 100 may identify the offline resource from one or more data elements obtained using any of the above-described means or other suitable means of data acquisition. For example, the web server 100 may obtain a telephone number related to the entity, but is unable to identify the entity from the phone number via the above online methods. As part of the identification step 1000, the web server 100 may generate an indication to an operator that the telephone number is an offline resource to be crawled as described below.

In other embodiments, the resource is identified through offline means, such as by observing, hearing, or receiving elements of the offline resource. Examples of observing include seeing a building or a photograph thereof, or viewing a bulletin board or a television broadcast. Examples of hearing include listening to a radio broadcast or a telephone call. Examples of receiving include obtaining a list of the entity's goods or services (e.g. a menu) or a printed advertisement (e.g. a flyer or brochure).

Once the offline resource is identified, at step 1005 information is obtained from the offline resource. The means by which the information is obtained may be non-electronic, in that an offline operator obtains the information and then submits it to the web server 100 for extraction of data elements as described below. The operator may be one or more people, a robotic device, or a combination thereof. Examples include crowd workers from services like Gigwalk or TaskRabbit, user-generated content from partners like TripAdvisor, robots, mined data from passively recording devices with geotagging such as Google Glass, and the like. The means by which the information is obtained by the operator may depend on the type of offline resource, with some non-limiting examples provided herein. Information may be obtained from offline resources viewed on the street (e.g. a building, billboard, or vehicle) by recording the address, the cross-streets, the name of the building, a list of businesses within the building as displayed on a road sign or other display, descriptive details related to the building or vehicle (e.g., “the building is a strip mall,” “the hours of operation are . . . ,” “the hot dog cart vendor's name is Job,” “the side of the vehicle reads ‘Job's Paint Jobs, 602-555-1212”’), and the like. Additionally or alternatively, the operator may take one or more photographs of the building, billboard, vehicle, or other display. The operator may obtain information from a printed document by scanning or photographing the document, or by dictating or transcribing some or all of the document's contents into an electronic format. The operator may record, transcribe, or recite information from a television or radio broadcast or a telephone call into a digital format. Similarly, the operator may make inquiries to a human offline resource, such as an employee (e.g., “what services do you offer?”) or customer (e.g., “how much did you pay for that?”), and record the resource's answers in a digital format. Communication with a human resource may be performed by a human operator or in automated fashion, such as by a robot dialer executing a prerecorded scripted inquiry over the telephone.

At step 1010, the web server 100 may receive the information from the operator. The operator may enter the information via any suitable input interface, including a desktop or mobile browser interface, email, FTP or other file server upload, and the like. The information received may consist solely of the relevant data elements, in which case the subsequent step 1015 of extracting the data elements maybe unnecessary. For more comprehensive information, at step 1015 the web server 100 may identify and extract one or more data elements from the information. The means by which the data elements are identified and extracted may depend on the type of offline resource and/or the format in which the information is provided. For example, a photograph of a building or other offline resource may be provided, and data elements identified extracted as explained above with respect to FIG. 3. Suitable extraction methods for such graphics, as well as structured or unstructured text, audio or video data, and other formats for the information are also described above. The extracted data elements may then be used as the seed input, as indicators of proper entity categorization, or as website content, as described above.

The acquisition mechanisms described above may be ranked. For example, the web server 100 or an operator may attempt to acquire offline data through a plurality of mechanisms. Because exploring each mechanism may incur an execution cost, ranking the sources of raw data given all of the information known about an entity is important. There are several factors to such a ranking.

An exemplary factor is the cost of a mechanism. Different acquisition mechanisms incur different costs. The costs also differ based on the entity being identified. For example, acquiring a price/service list by calling a merchant and synchronously asking them to provide their raw data incurs the cost of a language-proficient speaker that is available during the work hours of the merchant. Alternatively, acquiring a price/service list by email from a merchant incurs the cost of a data entry specialist who can asynchronously type up portions of the price/service list. These different human elements and components result in different costs to a company. Additionally, merchant-specific details affect the cost of acquisition. For example, calling a dry cleaner with five services and asking for the price of each likely costs less than calling a restaurant with more than 100 items on its menus. An algorithm such as a regression analysis can be used to estimate the expected cost of a mechanism utilizing contextual information about the merchant and other factors (e.g., the merchant's address/category/name, the time of day, the presence of language-speakers in the merchant's area, the presence of company agents in the merchant's area, the density of merchants in the area).

Another exemplary factor is the likelihood of success with a mechanism. Similar to estimating the cost of a mechanism of acquisition, the likelihood of success of a mechanism resulting in usable data elements must be estimated. For example, phone calls to dry cleaners may be more successful than phone calls to yoga studios, or phone calls at 11 am may be more successful than phone calls at 11 pm. Using tools such as regression analysis and contextual information similar to that described regarding the cost of a mechanism, the likelihood of success of a given mechanism may be estimated.

Another exemplary factor is the staleness, quality, and completeness of the mechanism. Another estimation problem involves the degree to which up-to-date, high-quality, complete information can be acquired through some mechanism. For example, an operator or his agent in a particular geogrpahic area may be identified as poor at taking photos of price/service lists, or a website may be determined to have out-of-date information. Similar to the techniques above, how useful the information acquired through a given mechanism will be may be estimated.

Another exemplary factor is budget allocation. There are several models for allocating a budget for acquisition. One exemplary model involves setting a budget per merchant and ranking the potential mechanisms of acquisition for that merchant. Each mechanism can be utilized (starting with the mechanism that is most likely to succeed) until either the merchant's price/service list has been acquired, or until the per-merchant budget has been expended. Another model for budget allocation involves setting a budget for several merchants (e.g., “We will spend no more than $1000 acquiring price/service lists for these 1000 merchants”). Then, which mechanisms to utilize on each merchant so that the entire budget across all merchants does not exceed the desired amount may be considered.

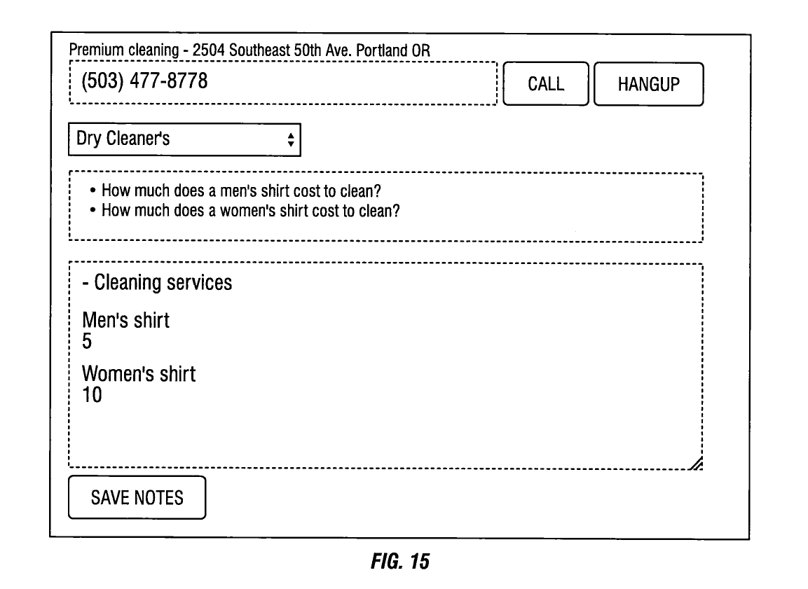

In many scenarios, the web server 100 may have an incomplete picture of a merchant's details before they begin acquiring their price/service list information. For example, a business listing for “Joan's Grooming Services” might describe a business that grooms pets or a beauty salon. If the business listing lacks a business category, or the business category in incorrect, the web server 100 will not a priori know what merchant-specific information to attempt to acquire. In particular, price/service list acquisition mechanisms must be resilient to incomplete or incorrect information. For certain acquisition mechanisms, such as a phone call, the ability to synchronously recover from mistakes and adjust to information as it is acquired is valuable. In some embodiments, acquisitions may be script-based. These scripts may be written for a person to read while interacting with a merchant, may be implemented as user interfaces that dynamically change the questions to ask a merchant as new information is updated in the form, or programmed into a computer so that the computer can acquire different information as it learns more contextual information about a merchant. While these scripts manifest themselves differently depending on the acquisition mechanism, they can be encoded as decision trees. For example, FIG. 14 depicts a decision tree, for determining whether a cleaning service cleans cars or clothing, that may be implemented as a script.

If an acquisition mechanism results in a price/service list in a form that can be processed with the workflow described herein, that price/service list can be inputted into the processing workflow and have its contents structured using automated and human-curated mechanisms. There are cases, however, when the price/service list is acquired in a way that prevents it from being handled by the previously described workflow (e.g., a phone call may require synchronous or asynchronous transcription). In these cases, company agents may use user interfaces to record their interactions with a merchant (e.g., recording a phone call, or taking notes that can be structured later). FIG. 15 depicts an exemplary user interface for recording information from a merchant.

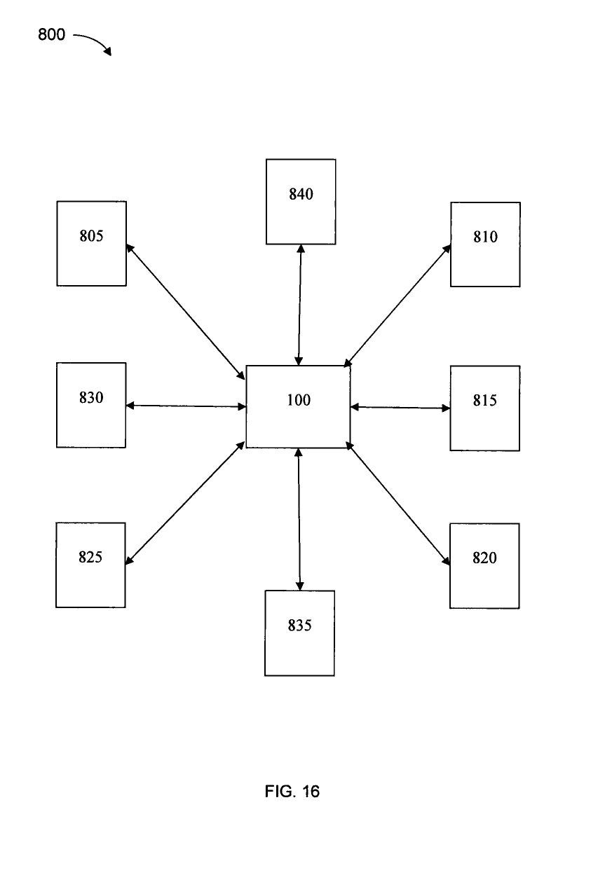

Referring to FIG. 16, a system 800 for performing the website generation methods described above may include the web server 100 and a plurality of modules for performing one or more steps of the methods. The modules may be hardware or software-based processing modules located within the web server 100, in close physical vicinity to the web server 100, or remote from the web server 100 and implemented as standalone server computers or as components of one or more additional servers or of one or more other computing devices, such as a payment terminal or cash register. The modules may include, without limitation: a user interface module 805 for providing input/output capabilities between the system 800 and the user; a data retrieval module 810 for performing the identification and content searches of data stores; a data processing module 815 for evaluating retrieved data for its value in identifying the entity or serving as potential content, and for identifying and categorizing the entity; a website generation module 820, which may be a component of the data processing module 815 or a separate module, and which populates an identified template as described above and stores the sample website; one or more data storage modules 825 for storing the data retrieved by the data retrieval module, the content objects created by the data processing module 815, the sample website generated by the website generation module 820, and the categorization structure and content framework used to generate websites; and a payment processing module 830 for processing payment information provided when a user chooses to purchase a generated website. The modules may further include a point-of-sale device interface module 835 for acquiring transaction information from one or more point-of-sale devices. The modules may further include an offline data aggregation module 840 for executing and managing offline crawling tasks and collecting offline data in electronic form.

The schematic flow chart diagrams included are generally set forth as logical flow-chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow-chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as preprogrammed hardware elements (e.g., application specific integrated circuits, FPGAs, and digital signal processors), or other related components.

In some embodiments, the disclosed apparatus and methods (e.g., see the various flow charts described above) may be implemented as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium.

The medium may be either a tangible medium (e.g., optical or analog communications lines) or a medium implemented with wireless techniques (e.g., WIFI, microwave, infrared or other transmission techniques). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software.

The present invention has been described in terms of one or more preferred embodiments, and it should be appreciated that many equivalents, alternatives, variations, and modifications, aside from those expressly stated, are possible and within the scope of the invention.

We claim:

1. A method, comprising:
obtaining, by a server computer communicatively coupled to an electronic network, a seed input, the seed input being associated with an entity;
using the seed input to identify the entity;
retrieving, by the server computer using at least one of the seed input and the identification of the entity, potential content relevant to the entity from one or more data stores; and
generating, by the server computer without an input from the entity, a website for the entity, the website comprising at least a portion of the potential content.

2. The method of claim 1, wherein the seed input includes one or more keywords.

3. The method of claim 1, wherein the seed input includes an image.

4. The method of claim 3, wherein using the seed input to identify the entity includes extracting one or more keywords from the image.

5. The method of claim 1, further comprising using the seed input to categorize the entity according to a categorization structure.

6. The method of claim 5, wherein retrieving the potential content includes using one or more categories relevant to the entity to identify the potential content.

7. The method of claim 6, wherein the template includes a plurality of content regions, and wherein generating the website further includes creating a plurality of content objects comprising at least a portion of the potential content and inserting one or more of the content objects into at least one of the content regions.

8. The method of claim 1, wherein obtaining the seed input includes receiving the seed input from the user.

9. The method of claim 1, wherein the seed input is obtained without input from the user.

10. The method of claim 9, wherein using the seed input to identify the entity comprises:
performing one or more identification searches of one or more first data stores;
obtaining, from the identification searches, one or more entity candidates;
storing the entity candidates in an entity candidate data store; and
identifying one of the entity candidates as the entity.

11. The method of claim 1, wherein obtaining the seed input comprises receiving, from a point-of-sale device in electronic communication with the server computer, transaction data for a transaction performed by the entity, and extracting the seed input from the transaction data.

12. The method of claim 1, wherein the website comprises one or more web pages within a larger website.

13. The method of claim 12, wherein the one or more web pages are profile pages and the larger website is a social networking website.

14. The method of claim 1, wherein the website comprises a vertical information portal.

15. A method, comprising: generating, by a server computer communicatively coupled to an electronic network and without an input from a user, a website, wherein the website includes content relevant to an entity retrieved from one or more first data stores.

16. The method of claim 15, further comprising offering the website to the user for purchase.

17. The method of claim 15, wherein generating the website comprises:
automatically obtaining a seed input from one or more second data stores; and
retrieving, using the seed input, the content relevant to the entity from one or more of the first data stores.

18. The method of claim 15, wherein generating the website further includes using the seed input to identify the entity.

19. The method of claim 15, wherein the website comprises one or more web pages within a larger website.

20. A method, comprising generating, by a server computer communicatively coupled to an electronic network, a website for an entity, the website having:
a layout derived from a template that is relevant to a category of the entity; and
a plurality of content regions arranged in the layout, each content region having inserted content identified by the server computer as relevant to the entity, the inserted content being identified as relevant using a seed input that the server computer uses to identify the entity.

21. The method of claim 20, wherein the template comprises a plurality of page layouts.

22. The method of claim 20, wherein the inserted content of each of the content regions has a particular type.

23. The method of claim 20, wherein generating the website comprises:
retrieving potential content from a plurality of data stores;
identifying, from the potential content, the inserted content for each content region; and
for each content region, inserting the inserted content into the content region.

24. The method of claim 20, wherein generating the website further comprises associating a first of the content regions with a first of the data stores, and wherein identifying the inserted content from the potential content comprises identifying the inserted content of the first content region from the potential content retrieved from the first data store.
